(19) United States
(12) Patent Application Publication
(10) Pub. No.: US 2011/0114901 A1
(43) Pub. Date: May 19, 2011

(54) Cellulose Acetate Film

(75) Inventors: Kinam Chung, Daejeon (KR); Myounglae Kim, Daejeon (KR); Jeeyoung Ahn, Seoul (KR); Hyukjun Kim, Daejeon (KR); Wonseok Jang, Daejeon (KR)

(73) Assignee: SK ENERGY CO., LTD., Seoul (KR)

(21) Appl. No.: 13/001,882

(22) PCT Filed: Jul. 8, 2009
(86) PCT No.: PCT/KR2009/003742

§ 371 Date: Dec. 29, 2010

(30) Foreign Application Priority Data
Jul. 10, 2008 (KR) 10-2008-0067012

(51) Int. Cl. G02F 1/361

(52) U.S. Cl. 252/582

(57) ABSTRACT

Provided is a cellulose acetate film for optical compensation, which has a low retardation value Rₜₕ in the film thickness direction.

### TECHNICAL FIELD

The present invention relates to a cellulose acetate film for optical compensation, more particularly to a cellulose acetate film with a low retardation value Rₜₕ in the film thickness direction.

The present invention also relates to an optical compensation sheet, a polarizing plate, and a liquid crystal display employing the cellulose acetate film.

### BACKGROUND ART

With good strength and flame retardance, cellulose acetate film is used for various photographic or optical materials. Compared with other polymer films, cellulose acetate film exhibits relatively low retardation due to low optical anisotropy. Accordingly, it is employed in polarizing plates or the like.

Recently, high qualities, including improved image quality, are demanded for liquid crystal displays. In this regard, appropriate characteristics are required for cellulose acetate film, which is used to prepare polarizing plates employed in the devices. In particular, cellulose acetate film used in in-plane switching (IPS) mode liquid crystal displays requires low optical anisotropy (Rₑ: retardation value in the film plane, Rₜₕ: retardation value in the film thickness direction) as a way of reducing color change and improving contrast. Accordingly, development of a cellulose acetate film satisfying this requirement is urgent.

### DISCLOSURE OF INVENTION

### Technical Problem

The present invention is directed to providing a cellulose acetate film with a low retardation value in the film thickness direction, as an optical film. More specifically, the present invention is directed to providing an optical compensation film capable of reducing color change and improving contrast of in-plane switching (IPS) mode liquid crystal displays.

Further, the present invention is directed to providing a retardation inhibitor for satisfying the optical characteristics.

Further, the present invention is directed to providing an optical compensation sheet, a polarizing plate, and a liquid crystal display employing the cellulose acetate film.

### Solution to Problem

The present invention provides a cellulose acetate film having superior optical characteristics, the cellulose acetate film exhibiting a retardation value in the film plane of 0 to 10 nm, and a retardation value in the film thickness direction of −12 to 25 nm.

More specifically, the present invention provides a cellulose acetate film with Rₑ (λ) and Rₜₕ (λ) satisfying the requirements of (I) and (II):

0≦Rₑ(588.9)≦10,|Rₜₕ(588.9)|≦25 (I)

|Rₑ(400)−Rₑ(700)|≦10,|Rₜₕ(400)−Rₜₕ(700)|≦35 (II)

wherein Rₑ (λ) is a retardation value (unit: nm) in the film plane at a wavelength λ (nm), and Rₜₕ (λ) is a retardation value (unit: nm) in the film thickness direction at a wavelength λ (nm).

To satisfy this requirement, the cellulose acetate film of the present invention may include one or more compound(s) represented by Chemical Formula 1 as an additive:

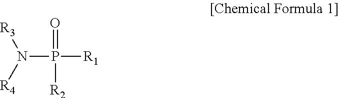

wherein

R₁ and R₂ independently represent

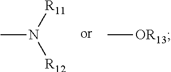

and R₃, R₄, R₁₁, R₁₂ and R₁₃ are independently selected from hydrogen, (C1-C7)alkyl, (C6-C20)aryl, (C3-C20)cycloalkyl, (C2-C7)alkenyl, 5- to 7-membered heterocycloalkyl containing one or more element(s) selected from N, O and S, and (C4-C20) heteroaryl containing one or more element(s) selected from N, O and S,

wherein the alkyl, aryl, cycloalkyl, alkenyl, heterocycloalkyl or heteroaryl of R₃, R₄, R₁₁, R₁₂ and R₁₃ may be further substituted by one or more substituent(s) selected from (C1-C7)alkyl, halogen, nitro, cyano, hydroxyl, amino, (C6-C20)aryl, (C2-C7)alkenyl, (C3-C20)cycloalkyl, 5- to 7-membered heterocycloalkyl containing one or more element(s) selected from N, O and S, and (C4-C20) heteroaryl containing one or more element(s) selected from N, O and S, and

R₃ and R₄, and R₁₁ and R₁₂ may be independently linked via (C3-C20)alkylene or (C3-C20)alkenylene to form an alicyclic ring, with the proviso that R₃, R₄, R₁₁, R₁₂ and R₁₃ are not hydrogens at the same time.

More specifically, in Chemical Formula 1, R₁ and R₂ independently represent

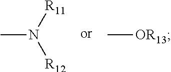

and R₃, R₄, R₁₁, R₁₂ and R₁₃ are independently selected from hydrogen, (C1-C5)alkyl, (C6-C12)aryl, (C3-C10)cycloalkyl, (C1-C5)alkenyl, 5- or 6-membered heterocycloalkyl containing one or more element(s) selected from N, O and S, and (C4-C10) heteroaryl containing one or more element(s) selected from N, O and S, wherein the alkyl, aryl, cycloalkyl, alkenyl, heterocycloalkyl or heteroaryl may be further substituted by one or more substituent(s) selected from hydrogen, (C1-C7)alkyl, amino, (C6-C20)aryl, (C2-C7)alkenyl and (C3-C20)cycloalkyl, and R₃ and R₄, and R₁₁ and R₁₂ may be independently linked via (C3-C10)alkylene or (C3-C10)alkenylene to form an alicyclic ring, with the proviso that R₃, R₄, R₁₁, R₁₂ and R₁₃ are not hydrogens at the same time.

Hereinafter, the embodiments of the present invention will be described in detail.

First, a description will be made about the cellulose acetate film. The cellulose acetate film according to the present invention may have a density of about 1.2 to 1.35, although not limited thereto.

The cellulose acetate film has a retardation value of −12 to 25 nm in the film thickness direction. Preferably, the retardation value in the film thickness direction is from −5 to 25 nm, more preferably from 0 to 25 nm, and most preferably from 0 to 15 nm.

Cellulose acetate is the acetate ester of cellulose, with all or part of hydrogen atoms of the hydroxyl groups at the 2-, 3- and 6-positions of glucose unit substituted by acetyl group(s). The degree of substitution of the cellulose acetate is preferably 2.7 or more, more preferably from 2.7 to 3.0, although not limited thereto. The degree of substitution may be determined according to ASTM D-817-91.

The cellulose acetate of the present invention preferably has a weight average molecular weight of 200,000 to 350,000, although not limited thereto. And, the cellulose acetate preferably has a molecular weight distribution M_{W}/Mₙ (M_{W}=weight average molecular weight, Mₙ=number average molecular weight) of 1.4 to 1.8, more preferably 1.5 to 1.7.

Preferably, the cellulose acetate film may be prepared by solvent casting using a cellulose acetate dope solution. In accordance with the solvent casting method, a dope solution in which cellulose acetate is dissolved in a solvent is cast on a support, and then the solvent is evaporated to form a film.

The cellulose acetate dope solution may preferably include cellulose acetate particles. Preferably, 90 wt % or more of the cellulose acetate particles have an average particle size of 0.5 to 5 mm. Also preferably, 50 wt % or more of the cellulose acetate particles have an average particle size of 1 to 4 mm.

Preferably, the cellulose acetate particles have a spherical shape if possible. And preferably, the cellulose acetate particles may be dried before preparing the dope solution so that the moisture content is 2 wt % or less, more preferably 1 wt % or less.

Next, additives included in the cellulose acetate film will be described.

The cellulose acetate solution (dope solution) used in the solvent casting may include various additives, e.g. plasticizer, UV stabilizer, degradation inhibitor, minute particles, release agent, IR absorber, optical anisotropy control agent, etc., depending on purposes. The additives commonly used in the related art may be used without limitation. Preferably, the content of the additives may be determined such that the physical properties of the film are not negatively affected. The additives may be added at different times depending on their kinds. The additives may be added at the last stage of the preparation of the dope solution.

The plasticizer is used to improve mechanical strength of the film. Use of the plasticizer may reduce the time required for drying the film. The plasticizer may be one commonly used in the art, without limitation. For example, phosphate ester or carboxylate ester selected from phthalate ester and citrate ester may be used. Examples of phosphate ester include triphenyl phosphate (TPP), biphenyldiphenyl phosphate, tricresyl phosphate (TCP), etc. Examples of phthalate ester include dimethyl phthalate (DMP), diethyl phthalate (DEP), dibutyl phthalate (DBP), dioctyl phthalate (DOP), diphenyl phthalate (DPP), diethylhexyl phthalate (DEHP), etc. Examples of citrate ester include o-acetyltriethyl citrate (OACTE), o-acetyltributyl citrate (OACTB), etc. Examples of other carboxylate ester include butyl oleate, methylacetyllysine oleate, dibutyl sebacate, and various trimellitate esters. Preferably, a phthalate ester (DMP, DEP, DBP, DOP, DPP or DEHP) plasticizer may be used. The plasticizer is used in an amount of 2 to 20 parts by weight, more preferably 5 to 15 parts by weight, based on 100 parts by weight of cellulose acetate.

The UV stabilizer may be a hydroxybenzophenone-based compound, a benzotriazole-based compound, a salicylate ester-based compound, a cyanoacrylate-based compound, or the like. The UV stabilizer is used in an amount of 0.1 to 3 parts by weight, more preferably 0.5 to 2 parts by weight, based on 100 parts by weight of cellulose acetate.

The degradation inhibitor may be, for example, antioxidant, peroxide decomposer, radical inhibitor, metal deactivator, oxygen scavenger, light stabilizer (e.g. hindered amine), etc. Particularly preferably examples of the degradation inhibitor include butylated hydroxytoluene (BHT) and tribenzylamine (TBA). The degradation inhibitor is used in an amount of 0.01 to 5 parts by weight, more preferably 0.1 to 1 part by weight, based on 100 parts by weight of cellulose acetate.

The minute particles are added to prevent curling, accompaniment and adhesion in roll form or to improve crack resistance of the film. The minute particles may be either an inorganic or an organic compound. Preferable examples of inorganic compound include those containing silicon, e.g. silicon dioxide, titanium oxide, zinc oxide, aluminum oxide, barium oxide, zirconium oxide, strontium oxide, antimony oxide, tin oxide, tin-antimony oxide, calcium carbonate, talc, clay, calcined kaolin, calcined calcium silicate, hydrated calcium silicate, aluminum silicate, magnesium silicate, calcium phosphate, etc. More preferably, silicon-containing inorganic compound, zirconium oxide, etc. may be used. The minute particles have an average primary particle size of 80 nm or smaller, preferably 5 to 80 nm, more preferably 5 to 60 nm, and particularly preferably 8 to 50 nm. If the average primary particle size exceeds 80 nm, surface flatness of the film may be deteriorated.

Next, a description will be made about the retardation inhibitor used in the present invention.

The retardation inhibitor is used to make the retardation value Rₜₕ in the film thickness direction close to zero. Preferably, it may be a compound represented by Chemical Formula 1:

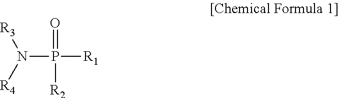

wherein

R₁ and R₂ independently represent

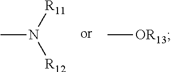

and R₃, R₄, R₁₁, R₁₂ and R₁₃ are independently selected from hydrogen, (C1-C7)alkyl, (C6-C20)aryl, (C3-C20)cycloalkyl, (C2-C7)alkenyl, 5- to 7-membered heterocycloalkyl containing one or more element(s) selected from N, O and S, and (C4-C20) heteroaryl containing one or more element(s) selected from N, O and S,

wherein the alkyl, aryl, cycloalkyl, alkenyl, heterocycloalkyl or heteroaryl of R₃, R₄, R₁₁, R₁₂ and R₁₃ may be further substituted by one or more substituent(s) selected from (C1-C7)alkyl, halogen, nitro, cyano, hydroxyl, amino, (C6-C20)aryl, (C2-C7)alkenyl, (C3-C20)cycloalkyl, 5- to 7-membered heterocycloalkyl containing one or more element(s) selected from N, O and S, and (C4-C20) heteroaryl containing one or more element(s) selected from N, O and S, and

R₃ and R₄, and R₁₁ and R₁₂ may be independently linked via (C3-C20)alkylene or (C3-C20)alkenylene to form an alicyclic ring, with the proviso that R₃, R₄, R₁₁, R₁₂ and R₁₃ are not hydrogens at the same time.

More specifically, in Chemical Formula 1, R₁ and R₂ independently represent

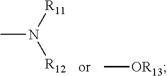

and R₃, R₄, R₁₁, R₁₂ and R₁₃ are independently selected from hydrogen, (C1-C5)alkyl, (C6-C12)aryl, (C3-C10)cycloalkyl, (C2-C5)alkenyl, 5- or 6-membered heterocycloalkyl containing one or more element(s) selected from N, O and S, and (C4-C10) heteroaryl containing one or more element(s) selected from N, O and S, wherein the alkyl, aryl, cycloalkyl, alkenyl, heterocycloalkyl or heteroaryl may be further substituted by one or more substituent(s) selected from hydrogen, (C1-C7)alkyl, amino, (C6-C20)aryl, (C2-C7)alkenyl and (C3-C20)cycloalkyl, and R₃ and R₄, and R₁₁ and R₁₂ may be independently linked via (C3-C10)alkylene or (C3-C10)alkenylene to form an alicyclic ring, with the proviso that R₃, R₄, R₁₁, R₁₂ and R₁₃ are not hydrogens at the same time.

In the present description, alkyl and other substituents including alkyl moiety include both linear and branched forms.

In the present description, aryl means an organic radical derived from an aromatic hydrocarbon by the removal of one hydrogen atom, and includes a 4- to 7-membered, preferably 5- or 6-membered, single or fused ring. Specific examples include phenyl, naphthyl, biphenyl, tolyl, etc., although not limited thereto.

In the present description, heteroaryl means an aryl group containing 1 to 3 heteroatom(s) selected from N, O and S as aromatic backbone atom(s), other aromatic backbone atoms being carbon. The heteroaryl group includes a secondary aryl group, wherein the heteroatom in the ring is oxidized or quaternized to form, for example, N-oxide or quaternary salt. Specific examples include furyl, thiophenyl, pyrrolyl, pyranyl, imidazolyl, pyrazolyl, thiazolyl, thiadiazolyl, isothiazolyl, isoxazolyl, oxazolyl, oxadiazolyl, triazinyl, tetrazinyl, triazolyl, tetrazolyl, furazanyl, pyridyl, pyrazinyl, pyrimidinyl, pyridazinyl, etc., although not limited thereto.

More specifically, in Chemical Formula 1, R₁ and R₂ independently represent

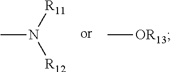

and R₃, R₄, R₁₁, R₁₂ and R₁₃ independently represent hydrogen, methyl, ethyl, n-propyl, i-propyl, n-butyl, i-butyl, t-butyl, n-pentyl, i-pentyl, n-hexyl, n-heptyl, n-octyl, 2-ethylhexyl, n-nonyl, decyl, dodecyl, hexadecyl, vinyl, allyl, butenyl, benzyl, phenyl, naphthyl, biphenyl or tolyl, and R₃ and R₄, and R₁₁ and R₁₂ may be independently linked via (C2-C3)alkylene to form an alicyclic ring (for example, R₃ and R₄, and R₁₁ and R₁₂ may be linked via (C2-C3)alkylene to form a pyrrolidine ring), with the proviso that R₃, R₄, R₁₁, R₁₂ and R₁₃ are not hydrogens at the same time.

More specifically, the compound represented by Chemical Formula 1 may be one or more compound(s) represented by Chemical Formulas 2 to 4, although not limited thereto:

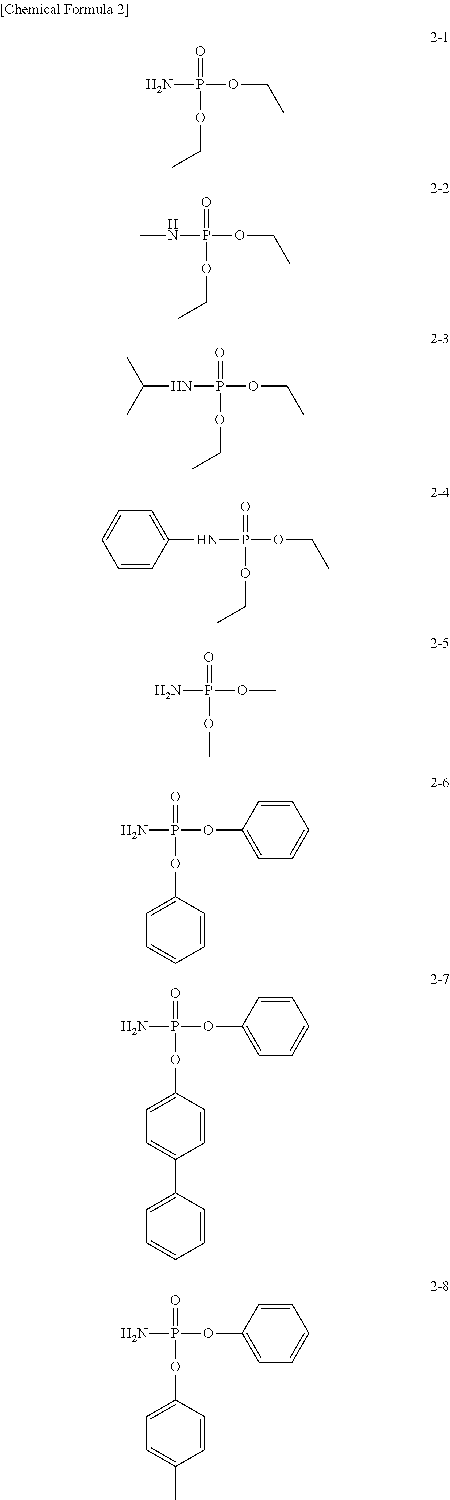

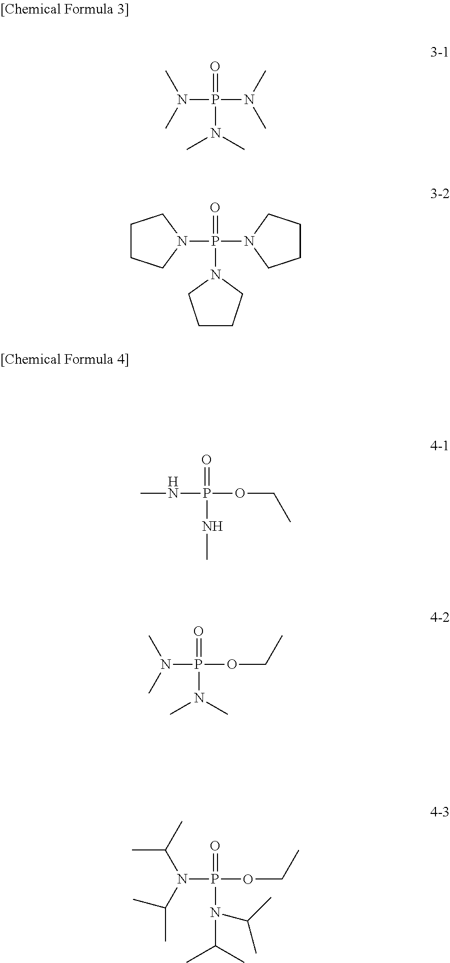

More preferably, the compound represented by Chemical Formula 1 may be selected from diethyl phosphoramidate represented by Chemical Formula 2-1, hexamethylphosphoramide represented by Chemical Formula 3-1, tris(N,N-tetramethylene)phosphoric acid triamide represented by Chemical Formula 3-2, and mixtures thereof, although not limited thereto.

Besides, optical anisotropy control agent, wavelength dispersion control agent, or the like may be further added, if necessary. These additives may be those commonly used in the art without special limitation.

Next, a description will be made about the method for preparing the cellulose acetate film according to the present invention.

In order to prepare the cellulose acetate film according to the present invention, a cellulose acetate composition, or a dope solution, is prepared as follows.

The cellulose acetate composition comprises 1 to 20 parts by weight of a retardation inhibitor represented by Chemical Formula 1, based on 100 parts by weight of cellulose acetate:

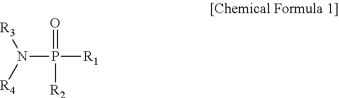

wherein

R₁ and R₂ independently represent

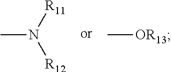

and R₃, R₄, R₁₁, R₁₂ and R₁₃ are independently selected from hydrogen, (C1-C7)alkyl, (C6-C20)aryl, (C3-C20)cycloalkyl, (C2-C7)alkenyl, 5- to 7-membered heterocycloalkyl containing one or more element(s) selected from N, O and S, and (C4-C20) heteroaryl containing one or more element(s) selected from N, O and S,

wherein the alkyl, aryl, cycloalkyl, alkenyl, heterocycloalkyl or heteroaryl of R₃, R₄, R₁₁, R₁₂ and R₁₃ may be further substituted by one or more substituent(s) selected from (C1-C7)alkyl, halogen, nitro, cyano, hydroxyl, amino, (C6-C20)aryl, (C2-C7)alkenyl, (C3-C20)cycloalkyl, 5- to 7-membered heterocycloalkyl containing one or more element(s) selected from N, O and S, and (C4-C20) heteroaryl containing one or more element(s) selected from N, O and S, and

R₃ and R₄, and R₁₁ and R₁₂ may be independently linked via (C3-C20)alkylene or (C3-C20)alkenylene to form an alicyclic ring, with the proviso that R₃, R₄, R₁₁, R₁₂ and R₁₃ are not hydrogens at the same time.

Preferably, the dope solution has a solid content of 15 to 25 wt %, more preferably 16 to 23 wt %. If the solid content of the dope solution is less than 15 wt %, film formation may be difficult because of too high fluidity. Otherwise, if it exceeds 25 wt %, a complete dissolution may not be attained.

In the present invention, the content of cellulose acetate is 70 wt % or more, preferably 70 to 90 wt %, more preferably 80 to 85 wt %, of the total solid contents. The cellulose acetate may be a mixture of two or more cellulose acetates having different degree of substitution, degree of polymerization or molecular weight distribution.

Preferably, the retardation inhibitor is used in an amount of 1 to 20 parts by weight based on 100 parts by weight of cellulose acetate.

In case the film is prepared by solvent casting, an organic solvent is preferred for a solvent for preparing the cellulose acetate composition (dope solution). Halogenated hydrocarbon is desirable for the organic solvent. Examples of the halogenated hydrocarbon include chlorohydrocarbon, methylene chloride and chloroform. Among them, methylene chloride is the most preferable.

Another organic solvent may be mixed with the halogenated hydrocarbon, if necessary. The organic solvent that may be used in addition to the halogenated hydrocarbon includes ester, ketone, ether, alcohol and hydrocarbon. The ester may be methyl formate, ethyl formate, propyl formate, pentyl formate, methyl acetate, ethyl acetate, pentyl acetate, etc. The ketone may be acetone, methyl ethyl ketone, diethyl ketone, diisobutyl ketone, cyclopentanone, cyclohexanone, methylcyclohexanone, etc. The ether may be diisopropyl ether, dimethoxymethane, dimethoxyethane, 1,4-dioxane, 1,3-dioxolane, tetrahydrofuran, anisole, phenetole, etc. The alcohol may be methanol, ethanol, 1-propanol, 2-propanol, 1-butanol, 2-butanol, t-butanol, 1-pentanol, 2-methyl-2-butanol, cyclohexanol, 2-fluoroethanol, 2,2,2-trifluoroethanol, 2,2,3,3-tetrafluoro-1-propanol, etc.

More preferably, methylene chloride may be used as main solvent, and alcohol may be used as cosolvent. Specifically, methylene chloride and alcohol may be mixed with a proportion of 80:20 to 95:5 based on weight.

The cellulose acetate composition may be prepared by dissolution at normal temperature, high temperature or low temperature.

Preferably, the cellulose acetate composition has a viscosity of 1 to 400 Pa·s, more preferably 10 to 200 Pa·s, at 40° C.

The cellulose acetate film may be prepared according to a common solvent casting method. More specifically, the prepared dope solution (cellulose acetate composition) is stored first in a reservoir, and foams included in the dope solution are removed. The defoamed dope solution is supplied from a dope solution outlet to a press die by a press type metric gear pump capable of pumping a constant amount of fluid with high precision depending on the number of revolutions. The dope solution is uniformly cast from a slit of the press die on a metal support which travels endlessly. At the separation point, where the metal support nearly completes a cycle, a still wet dope solution membrane (also called a web) is peeled off the metal support. Both ends of the web are fixed with clips to maintain the width. In this state, the web is dried as it is carried by a tenter. Subsequently, it is dried as being transferred to a roller of a dryer, and rolled with a given length.

During the casting of the solution, the space temperature is preferably −50° C. to 50° C., more preferably −30° C. to 40° C., and most preferably −20° C. to 30° C. Since the cellulose acetate solution cast at low space temperature is instantaneously cooled on the support, thereby improving gel strength, a lot of organic solvent remains in the resultant film. Accordingly, the film may be quickly peeled off the support without having to evaporate the organic solvent from the cellulose acetate solution. As commonly used in the art, air, nitrogen, argon or helium may be used to cool the space. Preferably, relative humidity is 0 to 70%, most preferably 0 to 50%.

Preferably, the temperature of the support (casting portion) on which the cellulose acetate solution is cast is −50 to 130° C., most preferably −30 to 25° C., and most preferably −20 to 15° C. To cool the casting portion, a cooled gas may be introduced to the casting portion. Alternatively, a cooling device may be disposed at the casting portion. During the cooling, it is important that water is not adhered to the casting portion. In case air is used for the cooling, the air may be dried in advance.

Also, the cellulose acetate film may be surface-treated, if necessary. The surface treatment is carried out in general to improve adhesivity of the cellulose acetate film. The surface treatment may include glow discharge treatment, UV treatment, corona treatment, flame treatment, saponification treatment, or the like.

The cellulose acetate film may be stretched to control the degree of retardation. Preferably, the degree of stretching is −10 to 100%, more preferably −10 to 50%, most preferably −5 to 30%.

Preferably, the cellulose acetate film has a thickness of 20 to 140 μm, more preferably 40 to 100 μm.

The cellulose acetate film according to the present invention may be employed in a polarizing plate, an optical compensation sheet or a liquid crystal display, and may be used as a single sheet or laminated into two or more sheets.

### Advantageous Effects of Invention

The cellulose acetate film according to the present invention exhibits a low retardation value in the film thickness direction.

### MODE FOR THE INVENTION

The examples will now be described. The following examples are for illustrative purposes only and not intended to limit the scope of the present invention.

Physical properties of the film were measured as follows.

1) Optical Anisotropy

Rₑ was measured using a birefringence analyzer (KOBRA-WPR, Oji Scientific Instrument) by irradiating light with a wavelength of 589 nm in a direction perpendicular to the film. Rₜₕ was measured by irradiating light with a wavelength of 589 nm in a direction 40 degrees from the normal of the film toward the slow axis in the Rₑ plane, determined using KOBRA-WPR.

### Comparative Example 1

### Preparation of Cellulose Acetate Composition (Dope Solution)

The following composition was added to a mixing tank and dissolved at 30° C. 2-(2H-Benzotriazol-2-yl)-6-(1-methyl-1-phenylethyl)-4-(1,1,3,3-tetramethylbutyl)phenol was used as UV stabilizer.

| Ingredients | Parts by weight |
|---|---|
| Cellulose acetate powder | 100 |
| (degree of substitution = 2.87) | |
| Triphenyl phosphate | 12 |
| UV stabilizer | 2 |
| Silicon dioxide | 0.5 |
| (average particle size = 16 nm) | |
| Methylene chloride | 440 |
| Methanol | 50 |

The resultant dope solution warmed to 30° C., transferred using a gear pump, filtered through filter paper with an absolute filtration precision of 0.01 mm, and then filtered using a cartridge filtration device with an absolute filtration precision of 5 μm.

Preparation of Cellulose Acetate Film

The filtered dope solution was cast on a slanted stainless steel support using a casting die, and then peeled off. The peeling was preformed so that the content of the remaining solvent was 20 to 40 wt %. After connecting to a tenter, the film was stretched by 105% in the width direction. When the film was taken out from the tenter, both sides of the film were cut by 150 mm. Then, the film was dried using a dryer. When the film was taken out from the dryer, both sides of the film were cut by 3 cm. Then, knurling processing was performed at 2 to 10 mm from the end portion, at a height of 100 μm, and the film was wound in the form of a roll. Retardation value Rₜₕ in the cellulose acetate film thickness direction was measured as described above.

### Examples 1-12

### Preparation of Cellulose Acetate Film

Cellulose acetate film was prepared in the same manner as Comparative Example 1, except that retardation inhibitors listed in Table 1 were added instead of triphenyl phosphate. After adding the additives of different amounts listed in Table 1 to a mixing tank based on 100 parts by weight of cellulose acetate powder, cellulose acetate compositions (dope solutions) were prepared by heating and agitating.

TABLE 1

| | | Contents (parts |
|---|---|---|
| | Additives | by weight) |
| Example 1 | Diethyl phosphoramidate | 2 |
| Example 2 | Diethyl phosphoramidate | 4 |
| Example 3 | Diethyl phosphoramidate | 6 |
| Example 4 | Diethyl phosphoramidate | 7 |
| Example 5 | Diethyl phosphoramidate | 8 |
| Example 6 | Diethyl phosphoramidate | 16 |
| Example 7 | Tris(N,N-tertramethylene)phosphoric | 8 |
| | acid triamide | |
| Example 8 | Tris(N,N-tertramethylene)phosphoric | 16 |
| | acid triamide | |
| Example 9 | Hexamethylphosphoramide | 8 |
| Example 10 | Hexamethylphosphoramide | 16 |
| Example 11 | N-Phenyldiethyl phosphoramidate | 7 |
| Example 12 | N-Phenyldiethyl phosphoramidate | 11 |

Film was prepared in the same manner as Comparative Example 1 using the prepared dope solution. Rₑ and Rₜₕ measurement results are given in Table 2.

TABLE 2

| | Rₑ | Rₜₕ |
|---|---|---|
| Comparative Example 1 | 3 | 50 |
| Example 1 | 0.5 | 41 |
| Example 2 | 0.5 | 30 |
| Example 3 | 0.5 | 16 |
| Example 4 | 1 | 8 |
| Example 5 | 2 | 3 |
| Example 6 | 1 | −5 |
| Example 7 | 2 | 5 |
| Example 8 | 2 | 5 |
| Example 9 | 1 | 17 |
| Example 10 | 2 | −5 |
| Example 11 | 0.6 | 18.8 |
| Example 12 | 0.7 | 6.4 |

As shown in Table 2, the films of the present invention to which optical anisotropy control agents were added exhibited low Rₑ and Rₜₕ values.

The present application contains subject matter related to Korean Patent Application No. 10-2008-0067012, filed in the Korean Intellectual Property Office on Jul. 10, 2008, the entire contents of which are incorporated herein by reference.

While the present invention has been described with respect to the specific embodiments, it will be apparent to those skilled in the art that various changes and modifications may be made without departing from the spirit and scope of the invention as defined in the following claims.

### INDUSTRIAL APPLICABILITY

In accordance with the present invention, optical compensation sheets with reduced color change and improved contrast characteristics for in-plane switching (IPS) mode liquid crystal displays can be provided for industrial purposes.

1-11. (canceled)

12. A cellulose acetate film comprising one or more inhibitor(s) reducing retardation (Rₜₕ) in the film thickness direction, which is represented by Chemical Formula 1: 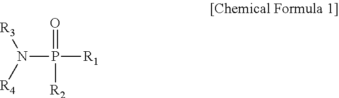
wherein
R₁ and R₂ independently represent 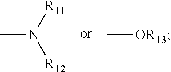
and R₃, R₄, R₁₁, R₁₂ and R₁₃ are independently selected from hydrogen, (C1-C7)alkyl, (C6-C20)aryl, (C3-C20)cycloalkyl, (C2-C7)alkenyl, 5- to 7-membered heterocycloalkyl containing one or more element(s) selected from N, O and S, and (C4-C20) heteroaryl containing one or more element(s) selected from N, O and S,
wherein the alkyl, aryl, cycloalkyl, alkenyl, heterocycloalkyl or heteroaryl of R₃, R₄, R₁₁, R₁₂ and R₁₃ may be further substituted by one or more substituent(s) selected from (C1-C7)alkyl, halogen, nitro, cyano, hydroxyl, amino, (C6-C20)aryl, (C2-C7)alkenyl, (C3-C20)cycloalkyl, 5- to 7-membered heterocycloalkyl containing one or more element(s) selected from N, O and S, and (C4-C20) heteroaryl containing one or more element(s) selected from N, O and S, and
R₃ and R₄, and R₁₁ and R₁₂ may be independently linked via (C3-C20)alkylene or (C3-C20)alkenylene to form an alicyclic ring, with the proviso that R₃, R₄, R₁₁, R₁₂ and R₁₃ are not hydrogens at the same time.

13. The cellulose acetate film according to claim 12,
wherein R₁ and R₂ independently represent 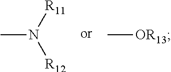
and R₃, R₄, R₁₁, R₁₂ and R₁₃ are independently selected from hydrogen, (C1-C5)alkyl, (C6-C12)aryl, (C3-C10)cycloalkyl, (C2-C5)alkenyl, 5- or 6-membered heterocycloalkyl containing one or more element(s) selected from N, O and S, and (C4-C10) heteroaryl containing one or more element(s) selected from N, O and S,
wherein the alkyl, aryl, cycloalkyl, alkenyl, heterocycloalkyl or heteroaryl may be further substituted by one or more substituent(s) selected from hydrogen, (C1-C7)alkyl, amino, (C6-C20)aryl, (C2-C7)alkenyl, (C3-C20)cycloalkyl, and
R₃ and R₄, and R₁₁ and R₁₂ may be independently linked via (C3-C10)alkylene or (C3-C10)alkenylene to form an alicyclic ring, with the proviso that R₃, R₄, R₁₁, R₁₂ and R₁₃ are not hydrogens at the same time.

14. The cellulose acetate film according to claim 13, wherein the compound represented by Chemical Formula 1 is selected from the following compounds:

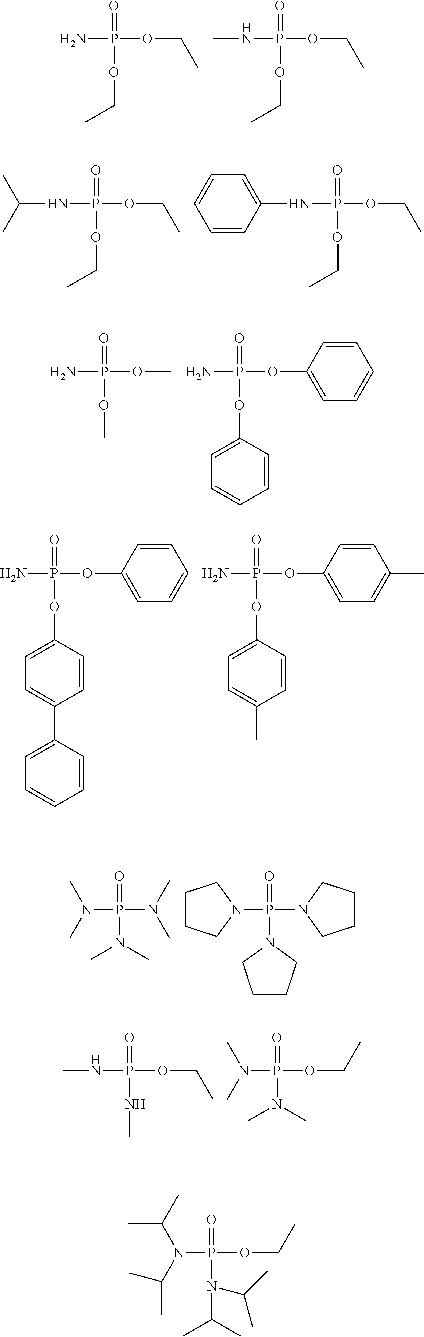

15. The cellulose acetate film according to claim 12,
wherein Rₑ (λ) and Rₜₕ (λ) of the film satisfy the requirements of (I) and (II):
0≦Rₑ(588.9)≦10,|Rₜₕ(588.9)|≦25, (I)

|Rₑ(400)−Rₑ(700)|≦10,|Rₜₕ(400)−Rₜₕ(700)|≦35 (II)
wherein Rₑ (λ) is a retardation value (unit: nm) in the film plane at a wavelength λ (nm), and Rₜₕ (λ) is a retardation value (unit: nm) in the film thickness direction at a wavelength λ (nm).

16. A cellulose acetate composition comprising 1 to 20 parts by weight of one or more retardation inhibitor(s) represented by Chemical Formula 1, based on 100 parts by weight of cellulose acetate: 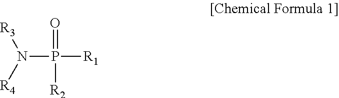
wherein
R₁ and R₂ independently represent 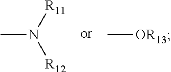
and R₃, R₄, R₁₁, R₁₂ and R₁₃ are independently selected from hydrogen, (C1-C7)alkyl, (C6-C20)aryl, (C3-C20)cycloalkyl, (C2-C7)alkenyl, 5- to 7-membered heterocycloalkyl containing one or more element(s) selected from N, O and S, and (C4-C20) heteroaryl containing one or more element(s) selected from N, O and S,
wherein the alkyl, aryl, cycloalkyl, alkenyl, heterocycloalkyl or heteroaryl of R₃, R₄, R₁₁, R₁₂ and R₁₃ may be further substituted by one or more substituent(s) selected from (C1-C7)alkyl, halogen, nitro, cyano, hydroxyl, amino, (C6-C20)aryl, (C2-C7)alkenyl, (C3-C20)cycloalkyl, 5- to 7-membered heterocycloalkyl containing one or more element(s) selected from N, O and S, and (C4-C20) heteroaryl containing one or more element(s) selected from N, O and S, and
R₃ and R₄, and R₁₁ and R₁₂ may be independently linked via (C3-C20)alkylene or (C3-C20)alkenylene to form an alicyclic ring, with the proviso that R₃, R₄, R₁₁, R₁₂ and R₁₃ are not hydrogens at the same time.

17. The cellulose acetate composition according to claim 16, wherein the composition further comprises one or more additive(s) selected from UV stabilizer, minute particles, plasticizer, degradation inhibitor, release agent, IR absorber, and optical anisotropy control agent.

18. A cellulose acetate film prepared from the cellulose acetate composition according to claim 16.

19. An optical compensation sheet comprising the cellulose acetate film according to claim 12.

20. An optical compensation sheet comprising the cellulose acetate film according claim 14.

21. An optical compensation sheet comprising the cellulose acetate film according to claim 15.

22. A polarizing plate comprising the cellulose acetate film according to claim 12.

23. A polarizing plate comprising the cellulose acetate film according to claim 14.

24. A polarizing plate comprising the cellulose acetate film according to claim 15.

25. A liquid crystal display comprising the cellulose acetate film according to claim 12.

26. A liquid crystal display comprising the cellulose acetate film according to claim 14.

27. A liquid crystal display comprising the cellulose acetate film according to claim 15.

28. The liquid crystal display according to claim 24, which is an in-plane switching (IPS) mode liquid crystal display.

29. The liquid crystal display according to claim 26, which is an in-plane switching (IPS) mode liquid crystal display.

30. The liquid crystal display according to claim 27, which is an in-plane switching (IPS) mode liquid crystal display.
